(19) United States
(12) Patent Application Publication
(10) Pub. No.: US 2025/0284467 A1
(43) Pub. Date: Sep. 11, 2025

(54) MODULAR MULTIPLIER, MODULAR MULTIPLICATION METHOD AND MODULAR MULTIPLICATION SYSTEM

(71) Applicant: Samsung Electronics Co., Ltd., Suwon-si (KR)

(72) Inventors: Gisoo SEO, Suwon-si (KR); Hyosun HWANG, Suwon-si (KR)

(73) Assignee: Samsung Electronics Co., Ltd., Suwon-si (KR)

(21) Appl. No.: 18/902,543

(22) Filed: Sep. 30, 2024

(30) Foreign Application Priority Data
Mar. 11, 2024 (KR) 10-2024-0033851

(51) Int. Cl. G06F 7/72; G06F 1/03; G06F 7/58

(52) U.S. Cl. CPC G06F 7/722; G06F 1/03; G06F 7/58

(57) ABSTRACT

A modular multiplier includes a random number generator that generates a random number, a memory that stores at least one lookup table including results of pre-computed modular arithmetic, and a processor that obtains results of modular arithmetic on partial products defined by a product of a first polynomial corresponding to a first input and a second polynomial corresponding to a second input with reference to the at least one lookup table, and generates a result of modular arithmetic on a product of the first input and the second input based on addition arithmetic of the obtained results of the modular arithmetic. The processor randomly determines at least one of an order of the addition arithmetic or an acquisition order of modular arithmetic results on the partial products based on the random number generated by the random number generator.

### CROSS-REFERENCE TO RELATED APPLICATIONS

This application claims the benefit of priority under 35 U.S.C. § 119 to Korean Patent Application No. 10-2024-0033851, filed on Mar. 11, 2024, in the Korean Intellectual Property Office, the disclosures of which are incorporated by reference herein in their entireties.

### TECHNICAL FIELD

Embodiments of the present disclosure described herein relate to a modular multiplier, a modular multiplication method, and a modular multiplication system.

### BACKGROUND

A side-channel attack refers to an attack for analyzing information (e.g., a computation time, power consumption of a device, electromagnetic waves generated by the device, or the like) generated during the physical implementation of a cryptographic scheme and obtaining information about decryption.

Lattice-based cryptographic algorithms (e.g., CRYSTALS-DILITHIUM, CRYSTALS-KYBER, and FALCON), which have been selected as general-purpose algorithms among post-quantum cryptography (PQC), may perform domain transformations, multiplications, and additions on polynomials defined over a quotient ring. In this case, secret information, such as a private key and a public key, is represented as coefficients of a polynomial and is the input/output of multiplication arithmetic and addition arithmetic, and thus the secret information may be the target of side-channel attacks through power consumption pattern analysis.

### SUMMARY

Embodiments of the present disclosure provide a modular multiplier, a modular multiplication method, and a modular multiplication system that may safely perform modular multiplication arithmetic against side-channel attacks.

According to an embodiment of the present disclosure, a modular multiplier includes a random number generator that generates a random number, a memory that stores at least one lookup table including results of pre-computed modular arithmetic, and a processor that obtains results of modular arithmetic on partial products defined by a product of a first polynomial corresponding to a first input and a second polynomial corresponding to a second input with reference to the at least one lookup table, and generates a result of modular arithmetic on a product of the first input and the second input based on addition arithmetic of the obtained results of the modular arithmetic. The processor randomly determines at least one of an order of the addition arithmetic or an acquisition order of modular arithmetic results on the partial products based on the random number generated by the random number generator.

In this embodiment, the processor may decompose the first input and the second input into the first polynomial and the second polynomial based on a decomposition factor, respectively.

In this embodiment, the partial products may be multiplication combinations of each term of the first polynomial developed based on the decomposition factor, and each term of the second polynomial developed based on the decomposition factor.

In this embodiment, the at least one lookup table may include a positive number table and a negative number table for each degree of the decomposition factor. The positive number table may include the results of the pre-computed modular arithmetic having a positive value as elements. The negative number table may include the results of the pre-computed modular arithmetic having a negative value as elements.

In this embodiment, the positive number table may include xr² elements having a value between 0 and xQ. The negative number table may include xr² elements having a value between −xQ and 0. The ‘r’ may be a value of the decomposition factor, the Q may be a value of modulus used in the modular arithmetic, and the ‘x’ may be one of positive integers.

In this embodiment, each of the results of the modular arithmetic on the partial products may have a value between −xQ and xQ.

In this embodiment, the processor may add a result of modular arithmetic, which is obtained with reference to the negative number table, to the intermediate result when an intermediate result of the addition arithmetic is a positive number, and may add a result of modular arithmetic, which is obtained with reference to the positive number table, to the intermediate result when the intermediate result of the addition arithmetic is a negative number.

In one embodiment, the processor may subtract xQ from the added value when a positive number is added to a positive number during the addition arithmetic, and may add xQ to the added value when a negative number is added to a negative number during the addition arithmetic.

In this embodiment, the processor may sequentially obtain the results of the modular arithmetic on the partial products depending on the determined order of the addition arithmetic and the determined acquisition order, and may sequentially perform the addition arithmetic depending on an order in which the results of the modular arithmetic are obtained.

In this embodiment, after obtaining all the results of the modular arithmetic on the partial products depending on the determined acquisition order, the processor may perform addition arithmetic of the obtained results of the modular arithmetic depending on the determined order of the addition arithmetic.

In this embodiment, the at least one lookup table may include a plurality of lookup table sets according to a value of the decomposition factor. The processor may determine one of the plurality of lookup table sets based on the random number generated by the random number generator, may respectively decompose the first input and the second input into the first polynomial and the second polynomial based on a value of a decomposition factor corresponding to the determined lookup table set, and may obtain the results of the modular arithmetic on the partial products with reference to elements of a lookup table included in the determined lookup table set.

In this embodiment, a value of modulus Q used in the modular arithmetic may be 8380417.

In this embodiment, the processor may decompose the ‘A’ and the ‘B’ based on Equation 1, when the first input is ‘A’ and the second input is ‘B’.

$$\begin{matrix}A = {\sum }_{0}^{n - 1} {a}_{i} \cdot {r}^{i} \\ B = {\sum }_{0}^{n - 1} {b}_{j} \cdot {r}^{j}\end{matrix}$$

Here, each of the ‘A’ and the ‘B’ may denote a number smaller than modulus Q used in the modular arithmetic, the ‘r’ may denote the decomposition factor, the Σ₀ⁿ⁻¹aᵢ·rⁱ may denote the first polynomial, the Σ₀ⁿ⁻¹bⱼ·r^{j} may denote the second polynomial, the ‘a’ may denote a coefficient of the first polynomial, the ‘b’ may denote a coefficient of the second polynomial, the ‘n’ may denote ceil(k/log₂(r)), the ceil may denote a function that rounds up to a nearest integer, and the ‘k’ may denote a number of bits of the modulus Q.

In this embodiment, when a product of the first polynomial and the second polynomial is expressed based on Equation 2, the partial products correspond to aᵢ·bⱼ·r^{i+j}.

$$A \cdot B = {\sum }_{0}^{n - 1} {\sum }_{0}^{n - 1} ( {a}_{i} \cdot {b}_{j} \cdot {r}^{i + j} )$$

According to another embodiment of the present disclosure, a modular multiplication method of a processor includes obtaining results of modular arithmetic on partial products defined by a product of a first polynomial corresponding to a first input and a second polynomial corresponding to a second input with reference to at least one lookup table including results of pre-calculated modular arithmetic, and generating a result of modular arithmetic on a product of the first input and the second input based on addition arithmetic of the obtained results of the modular arithmetic. At least one of an order of the addition arithmetic or an acquisition order of modular arithmetic results on the partial products is randomly determined.

In this embodiment, the method may further include decomposing the first input and the second input into the first polynomial and the second polynomial based on a decomposition factor, respectively. The partial products may be multiplication combinations of each term of the first polynomial developed based on the decomposition factor, and each term of the second polynomial developed based on the decomposition factor.

In this embodiment, the at least one lookup table may include a positive number table and a negative number table for each degree of a decomposition factor. The positive number table may include the results of the pre-computed modular arithmetic having a positive value as elements. The negative number table may include the results of the pre-computed modular arithmetic having a negative value as elements.

In this embodiment, the generating may include adding a result of modular arithmetic, which is obtained with reference to the negative number table, to the intermediate result when an intermediate result of the addition arithmetic is a positive number, and adding a result of modular arithmetic, which is obtained with reference to the positive number table, to the intermediate result when the intermediate result of the addition arithmetic is a negative number.

In this embodiment, the at least one lookup table may include a plurality of lookup table sets according to a value of the decomposition factor. The method may further include randomly determining one of the plurality of lookup table sets. The decomposing may include decomposing the first input and the second input into the first polynomial and the second polynomial based on a value of a decomposition factor corresponding to the determined lookup table set, respectively. The obtaining may include obtaining the results of the modular arithmetic on the partial products with reference to lookup tables included in the determined lookup table set.

According to still another embodiment of the present disclosure, a modular multiplication system includes a memory that stores an encryption algorithm, a processor that executes the encryption algorithm and provides a first input and a second input with a modular multiplier, and the modular multiplier that obtains results of modular arithmetic on partial products defined by a product of a first polynomial corresponding to the first input and a second polynomial corresponding to the second input with reference to at least one lookup table including results of pre-calculated modular arithmetic, and generates a result of modular arithmetic on a product of the first input and the second input based on addition arithmetic of the obtained results of the modular arithmetic. The modular multiplier randomly determines at least one of an order of the addition arithmetic or an acquisition order of modular arithmetic results on the partial products, and returns the generated result of the modular arithmetic on the product of the first input and the second input to the processor.

### BRIEF DESCRIPTION OF THE FIGURES

The above and other objects and features of the present disclosure will become apparent by describing in detail embodiments thereof with reference to the accompanying drawings.

FIG. 1 is a block diagram of a modular multiplier, according to an embodiment of the present disclosure.

FIG. 2 is a block diagram of a modular multiplier, according to an embodiment of the present disclosure.

FIG. 3A is a diagram illustrating an example of a positive number table, according to an embodiment of the present disclosure.

FIG. 3B is a diagram illustrating an example of a negative number table, according to an embodiment of the present disclosure.

FIG. 4 is an example diagram for describing modular multiplication arithmetic, according to embodiments of the present disclosure.

FIG. 5 is an example diagram for describing modular multiplication arithmetic, according to embodiments of the present disclosure.

FIG. 6 is an example diagram for describing modular multiplication arithmetic, according to embodiments of the present disclosure.

FIG. 7 is a flowchart of a modular multiplication method, according to an embodiment of the present disclosure.

FIG. 8 is a flowchart of a modular multiplication method, according to an embodiment of the present disclosure.

FIG. 9 is a flowchart of adjustment of an intermediate result, according to an embodiment of the present disclosure.

FIG. 10A is a diagram showing an implementation example of a modular multiplication system, according to an embodiment of the present disclosure.

FIG. 10B is a diagram showing an implementation example of a modular multiplication system, according to an embodiment of the present disclosure.

FIG. 10C is a diagram showing an implementation example of a modular multiplication system, according to an embodiment of the present disclosure.

### DETAILED DESCRIPTION

Below, embodiments of the present disclosure will be described with reference to accompanying drawings to facilitate the practice of the present disclosure by those skilled in the art in the technical field to which the present disclosure belongs.

In the present disclosure, expressions such as “first,” “second,” and the like may modify various components regardless of order and/or importance, and are only used to distinguish one component from another and do not limit the order or importance of the components.

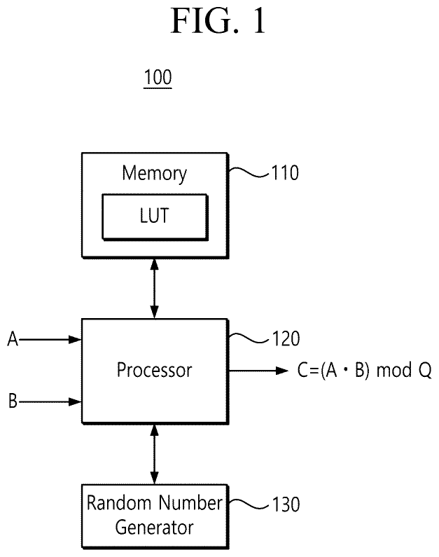

FIG. 1 is a block diagram of a modular multiplier, according to an embodiment of the present disclosure. Referring to FIG. 1, a modular multiplier 100 may include a memory 110, a processor 120, and a random number generator 130.

According to various embodiment of the present disclosure, the various functions including modular multiplication performed by the modular multiplier described hereinafter may be used in a post-quantum cryptography (PQC) application.

The memory 110 may be accessed by the processor 120 and may include at least one lookup table LUT. In this case, the at least one lookup table LUT may include the results of pre-computed modular arithmetic. In particular, the at least one lookup table LUT may include the results of the pre-computed modular arithmetic on partial products defined by the product of a first polynomial corresponding to a first input ‘A’ and a second polynomial corresponding to a second input ‘B’.

The memory 110 may refer to any storage medium that stores the at least one lookup table LUT. For example, the memory 110 may include a volatile memory such as a dynamic random access memory (DRAM), a static random access memory (SRAM), or the like. Moreover, the memory 110 may include a non-volatile memory such as a flash memory, a phase change RAM (PRAM), a ferroelectric RAM (FRAM), a resistive RAM (RRAM), and a magnetic RAM (MRAM). Furthermore, the memory 110 may include registers including a plurality of latches.

The random number generator 130 may generate random numbers. The random number generator 130 may generate random numbers in a random way. For example, the random number generator 130 may include a true random number generator and/or a pseudo random number generator. The random number generator 130 may include hardware logic and/or software function blocks for random number generation. The random number generator 130 according to an exemplary embodiment of the present disclosure may be an electric circuitry that executes instructions of software which thereby performs functions of random number generation.

In some embodiments, the random number generator 130 may generate a random number in response to a request from the processor 120. In addition, the random number generator 130 may generate a random number having a length according to the requirements of the processor 120. The random number generator 130 may provide the generated random number to the processor 120.

The processor 120 may control the overall operations of the modular multiplier 100. In particular, the processor 120 may receive the first input ‘A’ and the second input ‘B’ and may generate a result ‘C’ (i.e., a result of modular multiplication of the first input ‘A’ and the second input ‘B’) of modular arithmetic on the product of the first input ‘A’ and the second input ‘B’. In this case, the first input ‘A’ and the second input ‘B’ may be arbitrary multi-bit values that require modular multiplication during encryption or decryption operations in lattice-based encryption algorithms. For example, the first input ‘A’ may be a coefficient of a private key expressed as a polynomial, and the second input ‘B’ may be a coefficient of a public key expressed as a polynomial, but an embodiment is not limited thereto.

In detail, according to an embodiment of the present disclosure, the processor 120 may obtain the results of modular arithmetic on partial products defined by the product of the first polynomial corresponding to the first input ‘A’ and the second polynomial corresponding to the second input ‘B’, with reference to the at least one lookup table LUT stored in the memory 110. For example, the processor 120 may decompose the first input ‘A’ and the second input ‘B’ into the first polynomial and the second polynomial based on a decomposition factor, respectively. In this case, the partial products may be multiplication combinations of each term of the first polynomial developed based on the decomposition factor, and each term of the second polynomial developed based on the decomposition factor. Accordingly, the processor 120 may obtain the result of modular arithmetic on each of the partial products with reference to the at least one lookup table LUT.

Moreover, according to an embodiment of the present disclosure, the processor 120 may generate the result ‘C’ of the modular arithmetic on the product of the first input ‘A’ and the second input ‘B’ based on the addition arithmetic of the obtained results of modular arithmetic. The processor 120 may perform addition arithmetic on the obtained results of modular arithmetic. The result of adding all the results of modular arithmetic on the partial products may be “(A·B) mod Q”, which may be the result ‘C’ of the modular multiplication of the first input ‘A’ and the second input ‘B’ performed on the basis of modulus Q. According to an embodiment of the present disclosure, the result ‘C’ of the modular arithmetic on the product of the first input ‘A’ and the second input ‘B’ may be used in a PQC application.

In this case, according to an embodiment of the present disclosure, the processor 120 may randomly determine at least one of the acquisition order of modular arithmetic results on the partial products or the order of addition arithmetic.

For example, the processor 120 may randomly determine the acquisition order of modular arithmetic results on the partial products based on the random number received from the random number generator 130. As mentioned above, the result of modular arithmetic on the partial product is obtained with reference to the at least one lookup table LUT, and thus the acquisition order of results of modular arithmetic on partial products may be the order of partial products for referencing the at least one lookup table LUT. Moreover, the processor 120 may randomly determine the order of addition arithmetic of the obtained results of modular arithmetic based on the random number received from the random number generator 130.

In an embodiment, the processor 120 may sequentially obtain the results of modular arithmetic on partial products with reference to the at least one lookup table LUT depending on the determined acquisition order. Alternatively, the processor 120 may sequentially obtain the results of modular arithmetic on partial products with reference to the at least one lookup table LUT depending on the determined order of addition arithmetic. Accordingly, the processor 120 may sequentially perform addition arithmetic according to the order in which the results of modular arithmetic are obtained.

Alternatively, in an embodiment, the processor 120 may obtain all the results of modular arithmetic on partial products depending on the determined acquisition order and then may perform addition arithmetic depending on the determined order of addition arithmetic.

In the meantime, the processor 120 may have any structure that performs the above-described operations. For example, the processor 120 may include at least one programmable component (e.g., a processor), such as a central processing unit (CPU), a digital signal processor (DSP), a graphic processing unit (GPU), a neural network processing unit (NPU), or the like, may include a reconfigurable component such as a field programmable gate array (FPGA), and may include a component, which provides a fixed functions, such as an intellectual property (IP) core.

In the case of a general technology related to modular arithmetic, the pattern of power consumption during modular arithmetic or operation time may vary depending on an input value. This may be an attack point for a side-channel attack for identifying the input value of modular arithmetic.

According to various embodiments of the present disclosure, the modular multiplier 100 may decompose the product of the two inputs ‘A’ and ‘B’, which are the target of modular multiplication, into the sum of partial products and then may replace the modular arithmetic on the partial products with a lookup table reference. In this case, a difference in power consumption pattern depending on a difference in input value may be eliminated, and thus the modular multiplier 100 may be resistant to side-channel attacks.

According to some embodiments, the modular multiplier 100 may obtain the results of modular arithmetic on partial products in a randomly determined order and then may perform the addition arithmetic of the results of the modular arithmetic in the randomly determined order. In this case, even when the modular multiplication is performed on the same input value, a different power consumption pattern may appear each time. Accordingly, according to various embodiments of the present disclosure, modular multiplication arithmetic may be safely performed against side-channel attacks through power pattern analysis. For example, modular multiplication according to some embodiments may have more enhanced resistance to side-channel attacks in PQC. Therefore, modular multiplication according to some embodiments overcomes the deficiencies of the conventional devices and methods to at least improve the security level in PQC.

In the meantime, according to various embodiments of the present disclosure, the modular multiplier 100 may decompose the input values ‘A’ and ‘B’ into first and second polynomials, respectively, based on a decomposition factor and then may perform modular multiplication by using the results of modular arithmetic on partial products defined by the product of the first and second polynomials. Accordingly, a lookup table for modular multiplication may be configured by using a relatively small amount of memory compared to a general technology.

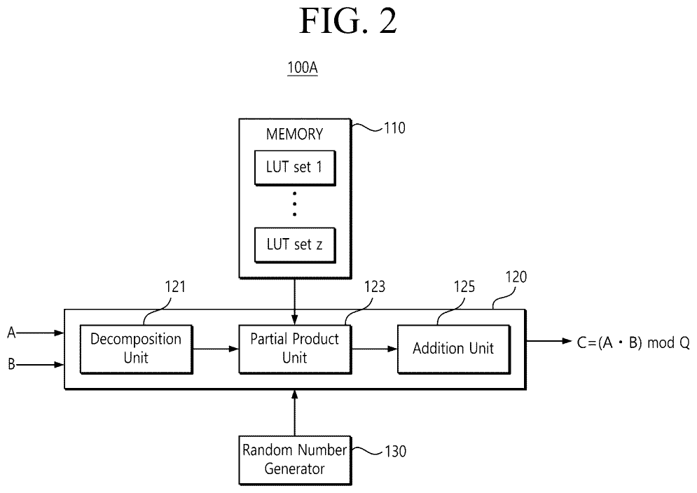

FIG. 2 is a block diagram of a modular multiplier, according to an embodiment of the present disclosure. The modular multiplier 100 in FIG. 2 may be an implementation example of the modular multiplier in FIG. 1, but is not limited thereto. Referring to FIG. 2, a modular multiplier 100A may include the memory 110, the processor 120, and the random number generator 130. In describing FIG. 2, description of content same as content described above with reference to FIG. 1 will be omitted to avoid redundancy.

The processor 120 may include a decomposition unit 121, a partial product unit 123, and an addition unit 125. The decomposition unit 121 of the processor 120 may decompose the first input ‘A’ and the second input ‘B’ into a first polynomial and a second polynomial, respectively, based on a decomposition factor.

For example, as shown in Equation 1 below, the decomposition unit 121 may decompose the first input ‘A’ and the second input ‘B’ into the first polynomial and the second polynomial, respectively.

$$\begin{matrix}A = {\sum }_{0}^{n - 1} {a}_{i} \cdot {r}^{i} \\ B = {\sum }_{0}^{n - 1} {b}_{j} \cdot {r}^{j}\end{matrix} \qquad [ Equation 1 ]$$

Here, each of ‘A’ and ‘B’ may denote a number smaller than modulus Q used in modular arithmetic; ‘r’ may denote a decomposition factor; Σ₀ⁿ⁻¹aᵢ·rⁱ may denote the first polynomial; Σ₀ⁿ⁻¹bⱼ·r^{j} may denote the second polynomial; ‘a’ may denote the coefficient of the first polynomial; and ‘b’ may denote the coefficient of the second polynomial. Furthermore, each of aᵢ and bⱼ may have a value greater than or equal to 0 and less than ‘r’.

In this case, according to an embodiment, ‘n’ may have the same value as a value in Equation 2 below.

$$n = ceil ( k / {log}_{2} ( r ) ) \qquad [ Equation 2 ]$$

Here, ‘ceil’ is a function that rounds up to the nearest integer, and ‘k’ may be the number of bits of modulus Q.

In this case, the result (i.e., (A·B) mod Q) of modular arithmetic on the product of the first input ‘A’ and the second input ‘B’ may be developed as in Equation 3 below.

$$( A \cdot B ) mod Q = {\sum }_{0}^{n - 1} {\sum }_{0}^{n - 1} ( {a}_{i} \cdot {b}_{j} \cdot {r}^{i + j} mod Q ) mod Q \qquad [ Equation 3 ]$$

Accordingly, the result of modular arithmetic on the product of the first input ‘A’ and the second input ‘B’ may be obtained by calculating the results (i.e., aᵢ·bⱼ·r^{i+j} mod Q) of modular arithmetic on partial products (i.e., aᵢ·bⱼ·r^{i+j}) defined by the product of the first polynomial and the second polynomial and summing the results.

According to an embodiment of the present disclosure, the partial product unit 123 of the processor 120 may respectively obtain the results (i.e., aᵢ·bⱼ·r^{i+j} mod Q) of modular arithmetic on partial products with reference to the at least one lookup table LUT. Moreover, the addition unit 125 of the processor 120 may generate the result ((A·B) mod Q) of modular arithmetic on the product of the first input ‘A’ and the second input ‘B’ by performing the addition arithmetic of the obtained results of modular arithmetic.

In detail, the partial product unit 123 may identify partial products (e.g., aᵢ·bⱼ·r^{i+j}) by identifying multiplication combinations of each term of the first polynomial (e.g., Σ₀ⁿ⁻¹aᵢ·rⁱ) developed based on a decomposition factor ‘r’ and each term of the second polynomial (e.g., Σ₀ⁿ⁻¹aᵢ·rⁱ) developed based on the decomposition factor ‘r’. Accordingly, the partial product unit 123 may obtain the result of modular arithmetic corresponding to the identified partial product with reference to the at least one lookup table LUT.

To this end, the memory 110 may include the at least one lookup table LUT including the results of pre-computed modular arithmetic on partial products.

According to an embodiment, the results (i.e., aᵢ·bⱼ·r^{i+j} mod Q) of modular arithmetic on partial products may have values in a range as shown in Equation 4 below.

$$- xQ < {a}_{i} \cdot {b}_{j} \cdot {r}^{i + j} mod Q < xQ \qquad [ Equation 4 ]$$

Here, ‘Q’ denotes a value of the modulus, and ‘x’ denotes a positive integer.

In this case, the at least one lookup table LUT may include positive number table(s) having a value between 0 and xQ and negative number table(s) having a value between −xQ and 0 for each degree of the decomposition factor ‘r’. In this case, each of the first polynomial (e.g., Σ₀ⁿ⁻¹aᵢ·rⁱ) and the second polynomial (e.g., Σ₀ⁿ⁻¹bⱼ·r^{j}) includes ‘n’ terms, and thus the product of the first polynomial and the second polynomial may include 2n−1 different terms from term r⁰ to term r²ⁿ⁻² based on the decomposition factor ‘r’. Accordingly, according to an embodiment, the at least one lookup table LUT may include x·(2n−1) positive number tables and x·(2n−1) negative number tables.

For example, in an embodiment where ‘x’ is 1, the results (i.e., aᵢ·bⱼ·r^{i+j} mod Q) of modular arithmetic on partial products may have a value between-Q and Q. In this case, the at least one lookup table LUT may include 2n−1 positive number tables having a value between 0 and Q, and 2n−1 negative number tables having a value between −Q and 0.

For another example, in an embodiment where ‘x’ is 2, the results (i.e., aᵢ·bⱼ·r^{i+j} mod Q) of modular arithmetic on partial products may have a value between −2Q and 2Q. In this case, the at least one lookup table LUT may include 2n−1 positive number tables having a value between 0 and Q, 2n−1 positive number tables having a value between Q and 2Q, 2n−1 negative number tables having a value between −2Q and −Q, and 2n−1 negative number tables having a value between −Q and 0. That is, the at least one lookup table LUT may include 2·(2n−1) positive number tables having a value between 0 and 2Q, and 2·(2n−1) negative number tables having a value between −2Q and 0.

For still another example, in an embodiment where ‘x’ is 3, the results (i.e., aᵢ·bⱼ·r^{i+j} mod Q) of modular arithmetic on partial products may have a value between −3Q and 3Q. In this case, the at least one lookup table LUT may include 2n−1 positive number tables having a value between 0 and Q, 2n−1 positive number tables having a value between Q and 2Q, 2n−1 positive number tables having a value between 2Q and 3Q, 2n−1 negative number tables having a value between −3Q and −2Q, 2n−1 negative number tables having a value between −2Q and −Q, and 2n−1 negative number tables having a value between −Q and 0. That is, the at least one lookup table LUT may include 3·(2n−1) positive number tables having a value between 0 and 3Q, and 3·(2n−1) negative number tables having a value between −3Q and 0.

In the meantime, each of the first coefficient (aᵢ) of the first polynomial and the second coefficient (bⱼ) of the second polynomial has a value greater than or equal to 0 and less than the decomposition factor ‘r’, the product (aᵢ·bⱼ) of the first coefficient of the first polynomial and the second coefficient of the second polynomial may have a value in a range that is greater than or equal to 0 and less than r². In other words, the number of cases of values indicated by the product (aᵢ·bⱼ) of the first coefficient of the first polynomial and the second coefficient of the second polynomial may be r². Accordingly, according to an embodiment, each of the positive number table(s) and the negative number table(s) for an arbitrary degree (r^{i+j}) of the decomposition factor ‘r’ may include x·r² elements.

As described above, in an embodiment where the results (i.e., aᵢ·bⱼ·r^{i+j} mod Q) of modular arithmetic on partial products have a value in the same range as the range in Equation 4, the total number of elements of the at least one lookup table LUT may be “2·x·r²·(2n−1)”. For example, in an embodiment where ‘x’ is 1, the at least one lookup table LUT may include 2r² (2n−1) elements. Moreover, in an embodiment where ‘x’ is 2, the at least one lookup table LUT may include 4r²(2n−1) elements. Furthermore, in an embodiment where ‘x’ is 3, the at least one lookup table LUT may include 6r²(2n−1) elements.

For example, in CRYSTALS-DILITHIUM, which is a lattice-based encryption algorithm where the value of 24-bit Q is 8380417, a general technology using a single lookup table in relation to modular multiplication requires Q² (i.e., 70231389093889) elements. Moreover, a general technology using log transformation and inverse transformation in relation to modular multiplication requires 2Q (i.e., 1676083) lookup table elements. On the other hand, according to embodiments of the present disclosure, assuming that ‘x’ is 1, it may be seen that the number of elements of the at least one lookup table LUT required for modular multiplication is required to be 655360 when ‘r’ is 2⁸ (=256), the number of elements is required to be 90112 when ‘r’ is 2⁶ (=64), the number of elements is required to be 5632 when ‘r’ is 2⁴ (=16), and the number of elements is required to be 736 when r is 2² (=4). In other words, according to embodiments of the present disclosure, a lookup table for modular multiplication may be configured by using a relatively small amount of memory compared to a general technology.

In the meantime, according to embodiments of the present disclosure, the partial product unit 123 may respectively obtain the results (i.e., aᵢ·bⱼ·r^{i+j} mod Q) of modular arithmetic on partial products depending on the order that is randomly determined based on the random number provided by the random number generator 130. In this case, as described above in FIG. 1, the randomly determined order may include the acquisition order of results of modular arithmetic on partial products or an order of addition arithmetic of the results of modular arithmetic.

In the meantime, for example, referring to Equation 2, when modulus Q is 24 bits and the decomposition factor ‘r’ is 2⁸ (=256), ‘n’ is 3. For example, as shown in Equation 5 below, the decomposition unit 121 may decompose the first input ‘A’ and the second input ‘B’.

$$\begin{matrix}A = {a}_{2} \cdot {256}^{2} + {a}_{1} \cdot 256 + {a}_{0} \\ B = {b}_{2} \cdot {256}^{2} + {b}_{1} \cdot 256 + {b}_{0}\end{matrix} \qquad [ Equation 5 ]$$

Here, each of a₂, a₁, a₀ and b₂, b₁, b₀ may have a value greater than or equal to 0 and less than 256.

In this case, the result of modular arithmetic on the product of the first input ‘A’ and the second input ‘B’ may be developed as in Equation 6 below.

$$( A \cdot B ) mod Q = \{ {a}_{2} \cdot {b}_{2} \cdot {256}^{4} + ( {a}_{2} \cdot {b}_{1} + {a}_{1} \cdot {b}_{2} ) \cdot {256}^{3} + ( {a}_{2} \cdot {b}_{0} + {a}_{1} \cdot {b}_{1} + {a}_{0} \cdot {b}_{2} ) \cdot {256}^{2} + ( {a}_{1} \cdot {b}_{0} + {a}_{0} \cdot {b}_{1} ) \cdot 256 + {a}_{0} \cdot {b}_{0} \} mod Q \qquad [ Equation 6 ]$$

Referring to Equation 6, it is seen that the result value does not change even when the order of adding the results of modular arithmetic on partial products (i.e., aᵢ·bⱼ·r^{i+j}) is different. Accordingly, according to an embodiment of the present disclosure, the addition unit 125 may perform addition arithmetic of the obtained results of modular arithmetic depending on the order randomly determined based on the random number provided by the random number generator 130.

In the meantime, according to an embodiment of the present disclosure, when the intermediate result of addition arithmetic is a positive number, the addition unit 125 may add the result of modular arithmetic, which is obtained with reference to the negative number table, to the intermediate result. When the intermediate result of addition arithmetic is a negative number, the addition unit 125 may add the result of modular arithmetic, which is obtained with reference to the positive number table, to the intermediate result. Alternatively, according to an embodiment of the present disclosure, when a positive number is added to a positive number during addition arithmetic, the addition unit 125 may subtract xQ from the added value. When a negative number is added to a negative number during addition arithmetic, the addition unit 125 may add xQ to the added value.

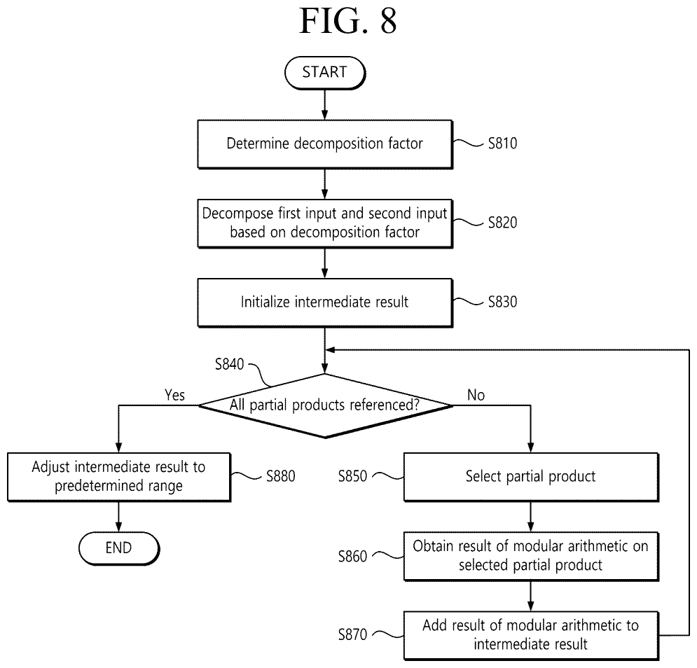

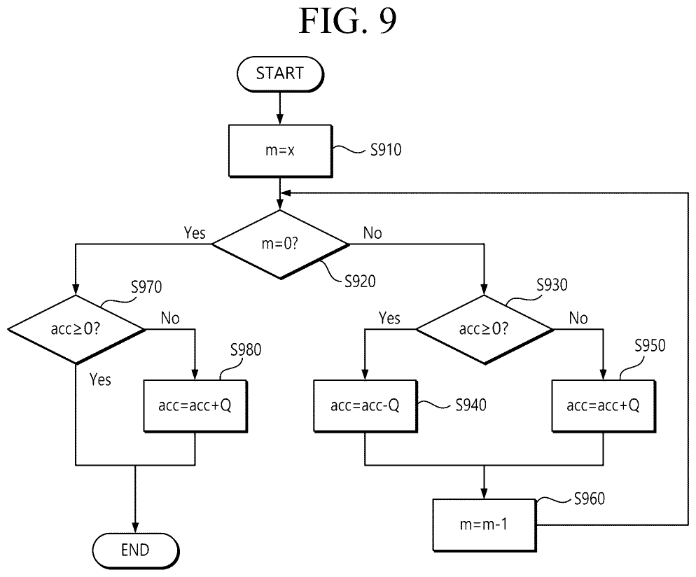

While the addition arithmetic of results of modular arithmetic on the partial product is performed when the addition arithmetic is performed in the manner described above, the value of the intermediate result may always be in a range greater than −xQ and less than xQ. In other words, in a process of performing addition arithmetic, there is no need for additional reduction operations of reducing the value of the intermediate result to a range greater than −xQ and less than xQ. Accordingly, according to an embodiment, only the arithmetic (e.g., operation S880 of FIG. 8 or FIG. 9) of adjusting the final result to the desired range (e.g., a range greater than or equal to 0 and less than Q) needs to be added, the computational cost required for modular multiplication may be reduced.

In the meantime, according to an embodiment of the present disclosure, the memory 110 may include at least one lookup table set LUT set 1 to LUT set z. In this case, each of the at least one lookup table sets LUT set 1 to LUT set z may include the results of the pre-calculated modular arithmetic corresponding to the value of the decomposition factor ‘r’ and/or the value of ‘x’ in Equation 4 as elements. According to an embodiment, each lookup table set LUT set 1 to LUT set z may include the at least one lookup table LUT.

For example, when the memory 110 includes the first to sixth lookup table sets, the first lookup table set LUT set 1 may include elements corresponding to the case where the decomposition factor is a first value and ‘x’ is the first value. Moreover, the second lookup table set LUT set 2 (not shown) may include elements corresponding to the case where the decomposition factor is the first value and ‘x’ is a second value. Furthermore, the third lookup table set LUT set 3 (not shown) may include elements corresponding to the case where the decomposition factor is the first value and ‘x’ is a third value. Also, the third lookup table set LUT set 4 (not shown) may include elements corresponding to the case where the decomposition factor is the second value and ‘x’ is the first value. Also, the fifth lookup table set LUT set 5 (not shown) may include elements corresponding to the case where the decomposition factor is the second value and ‘x’ is the second value. Also, the sixth lookup table set LUT set 6 (not shown) may include elements corresponding to the case where the decomposition factor is the second value and ‘x’ is the third value. However, an embodiment of the present disclosure is not limited thereto. According to system specifications, the memory 110 may include only the first lookup table set LUT set 1 or may include more than six lookup table sets.

According to an embodiment, the decomposition unit 121 may determine one of a plurality of lookup table sets based on the random number generated by the random number generator 130 and may respectively decompose the first input ‘A’ and the second input ‘B’ into the first polynomial and the second polynomial based on the value of a decomposition factor corresponding to the determined lookup table set. Accordingly, the partial product unit 123 may obtain the results of modular arithmetic on partial products with reference to the elements of the lookup table(s) included in the determined lookup table set.

According to an embodiment, the modular multiplier 100 or 100A may be implemented as hardware IP. Here, the hardware IP may refer to a reusable hardware function block. For example, each of components of the modular multiplier 100 or 100A may be implemented with an application specific integrated circuit (ASIC) or a field programmable gate array (FPGA), but is not limited thereto. The modular multiplier 100A implemented as the hardware IP may be included inside a system-on-chip (SoC) or may be implemented as a separate chip.

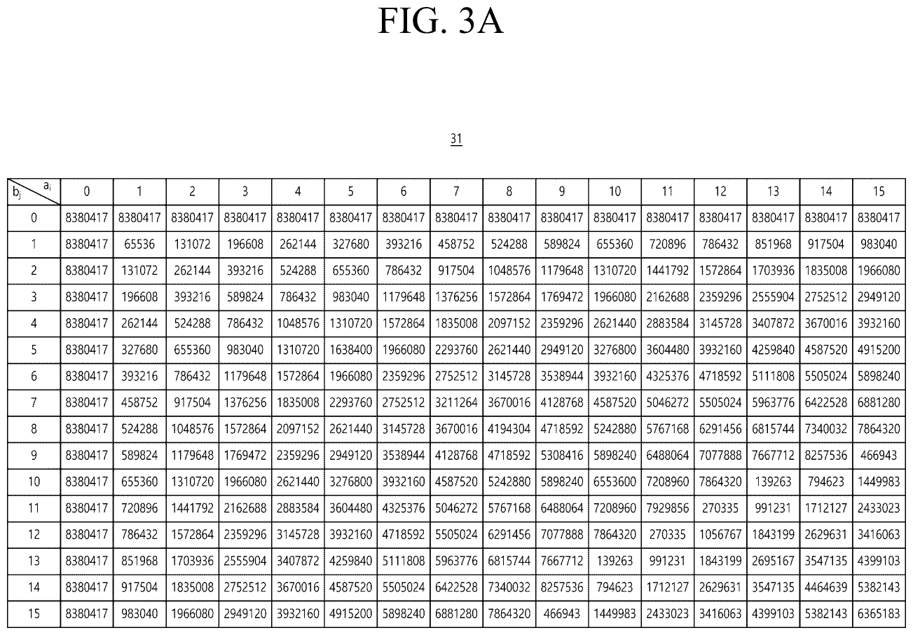

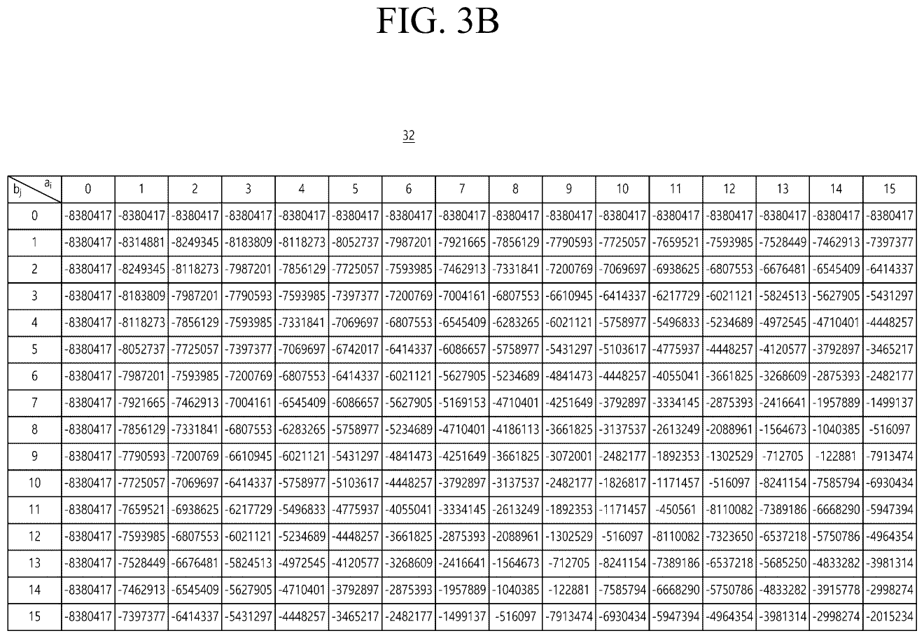

FIGS. 3A and 3B are diagrams illustrating an example of a positive number table and a negative number table, according to an embodiment of the present disclosure. FIGS. 3A and 3B respectively show examples of a positive number table 31 and a negative number table 32 for r⁴ in a lookup table set when a value of 24-bit modulus Q is 8380417, a value of the decomposition factor ‘r’ is 2⁴ (=16), and ‘x’ is 1.

In detail, in an embodiment where ‘x’ is 1, the results (i.e., aᵢ·bⱼ·r^{i+j} mod Q) of modular arithmetic on partial products may have a value between −Q and Q. In this case, the lookup table set may include positive number tables having a value between 0 and Q and negative number tables having a value between −Q and 0, for each degree of the decomposition factor ‘r’.

In an embodiment of FIGS. 3A and 3B, ‘k’ is 24 and ‘r’ is 2⁴ (=16). Accordingly, ‘n’ is 6, and thus the decomposition factor may have 11 degrees from 0 to 10. In this case, according to an embodiment of the present disclosure, the memory 110 may include 11 positive number tables, each of which includes 16² (=256) elements having a value between 0 and Q, and 11 negative number tables, each of which includes 16² (=256) elements having a value between −Q and 0. In other words, the total number of elements in the lookup table set may be “2·256·11” (i.e., 5632).

FIG. 3A shows an example of the positive number table 31 for r⁴ among 11 positive number tables corresponding to r⁰ to r¹⁰. FIG. 3B shows an example of the negative number table 32 for r⁴ among 11 negative number tables corresponding to r⁰ to r¹⁰.

As described above, each of a first coefficient (aᵢ) of a first polynomial and a second coefficient (bⱼ) of a second polynomial may have a value greater than or equal to 0 and less than the decomposition factor ‘r’. Referring to FIGS. 3A and 3B, it may be seen that aᵢ and bⱼ may have a value from 0 to 15 in each of the tables 31 and 32.

Moreover, as described above, in other words, the number of cases of values indicated by the product (aᵢ·bⱼ) of the first coefficient of the first polynomial and the second coefficient of the second polynomial may be r². Referring to FIGS. 3A and 3B, it may be seen that the number of elements (i.e., results of pre-calculated modular arithmetic) in the positive number table 31 and the negative number table 32 is 16² (=256).

In the meantime, referring to FIG. 3A, it may be seen that the positive number table 31 includes Q other than 0 as the result of modular arithmetic when aᵢ or bⱼ is 0. When modulus is Q, 0 and Q may have the same result of modular arithmetic. However, when 0 is used, singularity in a power consumption pattern may appear during a modular multiplication process. For this reason, this may be a point of attack for side-channel attack. Accordingly, according to an embodiment of the present disclosure, Q may be used instead of 0 as the result of modular arithmetic on a partial product. Likewise, it may be seen that the negative number table 32 of FIG. 3B also includes-Q other than 0 as the result of modular arithmetic when aᵢ or bⱼ is 0.

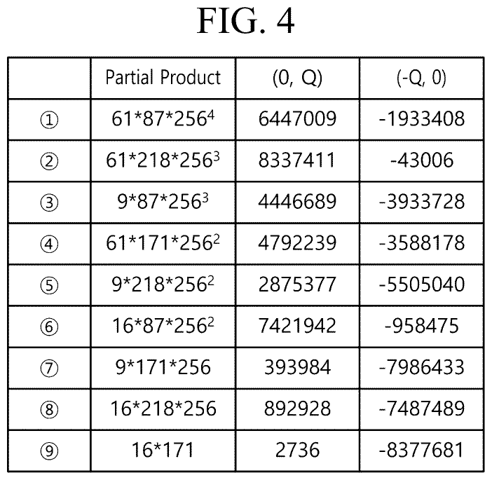

Hereinafter, various embodiments of the present disclosure will be described in detail with reference to FIGS. 4 to 6 by way of example.

FIG. 4 is an example diagram for describing modular multiplication arithmetic, according to embodiments of the present disclosure. For example, when the value of 24-bit modulus Q is 8384017, the decomposition factor ‘r’ is 28, the first input ‘A’ is 4000016, and the second input ‘B’ is 5757611, the processor 120 may decompose ‘A’ and ‘B’ as shown in Equation 7 below.

$$\begin{matrix}A = 4000016 = 61 \cdot {256}^{2} + 9 \cdot 256 + 16 \\ B = 5757611 = 87 \cdot {256}^{2} + 218 \cdot 256 + 171\end{matrix} \qquad [ Equation 7 ]$$

In the meantime, when the product of ‘A’ and ‘B’ is developed depending on the degree of the decomposition factor ‘r’, Equation 8 below is obtained.

$$A \cdot B = 61 \cdot 87 \cdot {256}^{4} + ( 61 \cdot 218 + 9 \cdot 87 ) \cdot {256}^{3} + ( 61 \cdot 171 + 9 \cdot 218 + 16 \cdot 87 ) \cdot {256}^{2} + ( 9 \cdot 171 + 16 \cdot 218 ) \cdot 256 + 16 \cdot 171 \qquad [ Equation 8 ]$$

In FIG. 4, “Partial Product” indicates 9 partial products included in Equation 8; (0, Q) indicates a positive number table value for the corresponding partial product; and, (−Q, 0) indicates a negative number table value for the corresponding partial product.

For example, the processor 120 may perform addition arithmetic in the order of “(\textcircled{1}+\textcircled{3}+\textcircled{5}+\textcircled{7}+\textcircled{9}+\textcircled{2}+\textcircled{4}+\textcircled{6}+\textcircled{8}”. In this case, according to an embodiment, a value (−1933408) obtained by referencing the negative number table may be used as a partial product ({circle around (1))}) (i.e., the result of modular arithmetic on 61·87·2564) that is added first. In the meantime, when an intermediate result of addition arithmetic is a positive number, the processor 120 may add the result of modular arithmetic, which is obtained with reference to the negative number table, to the intermediate result. When the intermediate result of addition arithmetic is a negative number, the processor 120 may add the result of modular arithmetic, which is obtained with reference to the positive number table, to the intermediate result. In this case, referring to FIG. 4, the value of “(A·B) mod Q” may be “−6291770” by performing calculations of “(−1933408)+4446689+(−5505040)+393984+2736+8337411+(−3588178)+(−958475)+(−7487489)”.

Moreover, for example, the processor 120 may perform addition arithmetic in the order of “(\textcircled{1}+\textcircled{3}+\textcircled{5}+\textcircled{7}+\textcircled{9}+\textcircled{2}+\textcircled{4}+\textcircled{6}+\textcircled{8}”. In this case, according to an embodiment, a value (6447009) obtained by referencing the positive number table may be used as a partial product (\textcircled{1}) (i.e., the result of modular arithmetic on 61·87·2564) that is added first. In the meantime, when an intermediate result of addition arithmetic is a positive number, the processor 120 may add the result of modular arithmetic, which is obtained with reference to the negative number table, to the intermediate result. When the intermediate result of addition arithmetic is a negative number, the processor 120 may add the result of modular arithmetic, which is obtained with reference to the positive number table, to the intermediate result. In this case, referring to FIG. 4, the value of “(A·B) mod Q” may be “−6291770” by performing calculation of “6447009+(−3933728)+(−5505040)+393984+2736+8337411+(−3588178)+(−958475)+(−7487489)”.

Moreover, for example, the processor 120 may perform addition arithmetic in the order of “\textcircled{7}+\textcircled{2}+\textcircled{1}+\textcircled{8}+\textcircled{3}+\textcircled{6}+\textcircled{5}+\textcircled{4}+\textcircled{9}”. In this case, when the intermediate result of addition arithmetic is a positive number, the processor 120 may add the result of modular arithmetic, which is obtained with reference to the negative number table, to the intermediate result. When the intermediate result of addition arithmetic is a negative number, the processor 120 may add the result of modular arithmetic, which is obtained with reference to the positive number table, to the intermediate result. In this case, referring to FIG. 4, the value of “(A·B) mod Q” may be “6291770” by performing calculation of “393984+(−43006)+(−1933408)+892928+4446689+(−958475)+(−5505040)+4792239+(−8377681)”.

Referring to the result of the three examples above, it may be seen that the result value does not change even though the order of adding the results of modular arithmetic on partial products changes when inputs are the same as each other. Moreover, when inputs are the same as each other, it may be seen that the result value does not change regardless of whether a value obtained by referencing a positive number table or a value obtained by referencing a negative number table is used as the result of modular arithmetic on a partial product that is first added.

In the meantime, according to an embodiment of the present disclosure, the processor 120 may obtain the result of modular arithmetic on partial products by randomly referencing values of the positive number table and the negative number table. In this case, when a positive number is added to a positive number during addition arithmetic, the processor 120 may subtract xQ from the added value. When a negative number is added to a negative number during addition arithmetic, the processor 120 may add xQ to the added value.

For example, the processor 120 may perform addition arithmetic in the order of “(((\textcircled{1}+ \textcircled{3})+(\textcircled{5}+\textcircled{7})+((\textcircled{9}+\textcircled{2})+(\textcircled{4}+\textcircled{6})))+\textcircled{8}”. In this case, the processor 120 may randomly reference values of the positive number table and the negative number table. For example, \textcircled{1} may be obtained as 6447009 with reference to the positive number table; \textcircled{3} may be obtained as 4446689 with reference to the positive number table; \textcircled{5} may be obtained as 2875377 with reference to the positive number table; \textcircled{7} may be obtained as-7986433 with reference to the negative number table; \textcircled{9} may be obtained as −8377681 with reference to the negative number table; \textcircled{2} may be obtained as −43006 with reference to the negative number table; \textcircled{4} may be obtained as −3588178 with reference to the negative number table; \textcircled{6} may be obtained as 7421942 with reference to the positive number table; and, \textcircled{8} may be obtained as 892928 with reference to the positive number table.

In this case, first of all, the processor 120 may perform calculations of “(((6447009+4446689−8380417)+(2875377+(−7986433)))+(((−8377681)+(−43006)+8380417)+((−3588178)+7421942)))+892928” depending on the order of addition arithmetic such as “((((\textcircled{1}+\textcircled{3})+(\textcircled{5}+\textcircled{7}))+((\textcircled{9}+\textcircled{2})+(\textcircled{4}+\textcircled{6})))+\textcircled{8}”. In this case, both \textcircled{1} and \textcircled{3} are values obtained by referencing the positive number table, and thus it may be seen that −Q operation is performed on a value obtained by adding \textcircled{1} and \textcircled{3}. Both \textcircled{9} and \textcircled{2} are values obtained by referencing the negative number table, and thus it may be seen that +Q operation is performed on a value obtained by adding \textcircled{9} and \textcircled{2}.

The result of the above-described addition arithmetic may be “((2513281+(−5111056))+((−40270)+3833764))+892928”. The processor 120 may perform addition arithmetic on “((2513281+(−5111056))+((−40270)+3833764))+892928” and may obtain a result such as “((−2597775)+3793494)+892928”.

Afterward, the processor 120 may perform addition arithmetic on “((−2597775)+3793494)+892928”. In this case, because the result of “((−2597775)+3793494)” is 1195719, a situation, in which positive numbers are added again, such as “1195719+892928” may occur. Accordingly, the processor 120 may finally obtain the result such as −6291770 by performing-Q operation again on the result obtained by adding 1195719 and 892928. Even in this case, it may be seen that the final result is the same as results in the three examples described above.

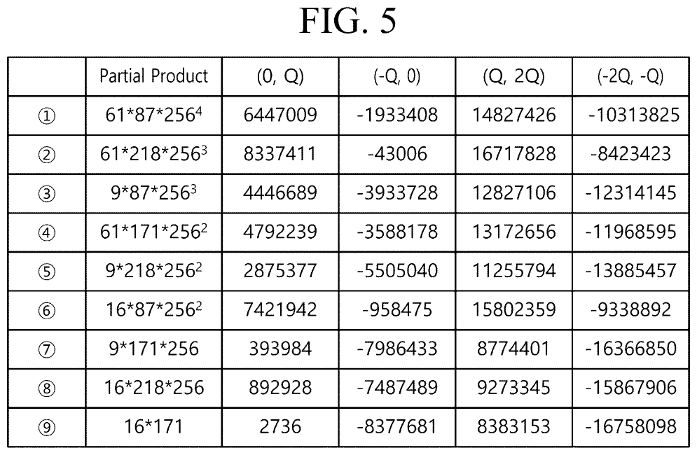

FIG. 5 is an example diagram for describing modular multiplication arithmetic, according to embodiments of the present disclosure. FIG. 5 shows the case where ‘x’ is 2 in Equation 4 (i.e., the case where a range of a lookup table referenced to obtain the result of modular arithmetic is expanded from-2Q to 2Q). In this case, values of modulus Q, the decomposition factor ‘r’, the first input ‘A’, and the second input ‘B’ are the same as values in the example in FIG. 4.

In detail, referring to FIG. 5, “Partial Product”, (0, Q), and (−Q, 0) is the same as those in FIG. 4. However, when the value of ‘x’ is 2, the results of modular arithmetic on partial products may have a value between −2Q and 2Q. Accordingly, it may be seen that a positive number table having a value between Q and 2Q and a negative number table having a value between −2Q and −Q are added.

As such, when the lookup table is expanded, results of modular arithmetic on partial products may be variously obtained. Accordingly, even when modular multiplication is performed on the same input value, power consumption patterns may appear variously. Accordingly, according to an embodiment of the present disclosure, modular multiplication arithmetic may be performed safely against side-channel attacks.

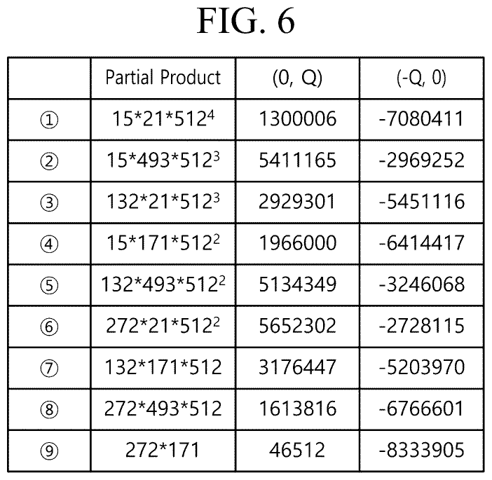

FIG. 6 is an example diagram for describing modular multiplication arithmetic, according to embodiments of the present disclosure. FIG. 6 shows that a value of the decomposition factor ‘r’ is 2⁹ (=512). In this case, values of modulus Q, ‘x’, the first input ‘A’, and the second input ‘B’ are the same as values in the example in FIG. 4.

In this case, the processor 120 may decompose ‘A’ and ‘B’ as shown in Equation 9 below.

$$\begin{matrix}A = 4000016 = 15 \cdot {512}^{2} + 132 \cdot 512 + 272 \\ B = 5757611 = 21 \cdot {512}^{2} + 493 \cdot 512 + 171\end{matrix} \qquad [ Equation 9 ]$$

In the meantime, when the product of ‘A’ and ‘B’ is developed depending on the degree of the decomposition factor ‘r’, Equation 10 below is obtained.

$$A \cdot B = 15 \cdot 21 \cdot {512}^{4} + ( 15 \cdot 493 + 132 \cdot 21 ) \cdot {512}^{3} + ( 15 \cdot 171 + 132 \cdot 493 + 272 \cdot 21 ) \cdot {512}^{2} + ( 132 \cdot 171 + 272 \cdot 493 ) \cdot 512 + 272 \cdot 171 \qquad [ Equation 10 ]$$

In FIG. 6, “Partial Product” indicates 9 partial products included in Equation 10; (0, Q) indicates a positive number table value for the corresponding partial product; and, (−Q, 0) indicates a negative number table value for the corresponding partial product.

For example, the processor 120 may perform addition arithmetic in the order of “(\textcircled{1}+\textcircled{3}+\textcircled{5}+\textcircled{7}+\textcircled{9}+\textcircled{2}+\textcircled{4}+\textcircled{6}+\textcircled{8}”. In this case, when the intermediate result of addition arithmetic is a positive number, the processor 120 may add the result of modular arithmetic, which is obtained with reference to the negative number table, to the intermediate result. When the intermediate result of addition arithmetic is a negative number, the processor 120 may add the result of modular arithmetic, which is obtained with reference to the positive number table, to the intermediate result. In this case, referring to FIG. 6, the value of “(A·B) mod Q” may be “−6291770” by performing calculations of “(−7080411)+2929301+5134349+(−5203970)+46512+5411165+(−6414417)+5652302+(−6766601)”.

Referring to the above-described result and the example in FIG. 4, it may be seen that the result of the same modular multiplication is generated with respect to the same inputs ‘A’ and ‘B’. However, because values of elements of a lookup table change when the value of the decomposition factor ‘r’ changes, different intermediate results from each other may be shown with respect to the same inputs ‘A’ and ‘B’. Accordingly, according to an embodiment of the present disclosure, the resistance to side-channel attacks may be increased by randomly selecting a decomposition factor and performing modular multiplication.

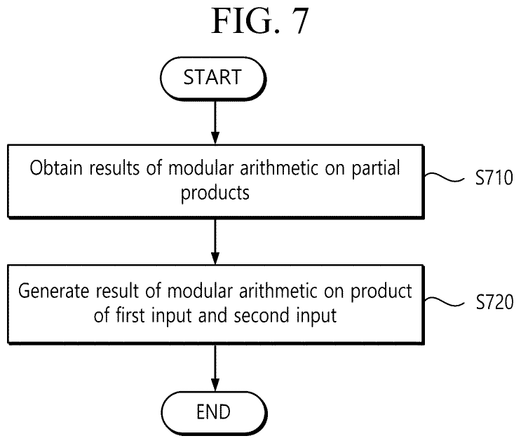

FIG. 7 is a flowchart of a modular multiplication method, according to an embodiment of the present disclosure. In describing FIG. 7, description of content the same as content described above will be omitted to avoid redundancy.

According to an embodiment, an operation of the above-described modular multiplier 100 or 100A may be implemented with software IP. In an embodiment, each of the decomposition unit 121, the partial product unit 123, and/or the addition unit 125 described above may be implemented as software IP. In this case, the processor 120 may perform operations of the decomposition unit 121, the partial product unit 123, and/or the addition unit 125 by executing the decomposition unit 121, the partial product unit 123 and/or the addition unit 125, respectively.

Referring to FIG. 7, in operation S710, the processor 120 may obtain results of modular arithmetic on partial products defined by the product of a first polynomial corresponding to a first input and a second polynomial corresponding to a second input. In this case, the processor 120 may obtain the results of modular arithmetic on partial products with reference to the at least one lookup table LUT including the results of the pre-calculated modular arithmetic.

In detail, the processor 120 may decompose the first input ‘A’ and the second input ‘B’ into the first polynomial and the second polynomial based on a decomposition factor, respectively. Moreover, the processor 120 may identify multiplication combinations of each term of the first polynomial developed based on the decomposition factor and each term of the second polynomial developed based on the decomposition factor as the partial products and may obtain the results of modular arithmetic on the identified partial products.

In an embodiment, when the number of terms in each of the first polynomial and the second polynomial is ‘n’, the number (i.e., the number of partial products) of multiplication combinations of each term of the first polynomial and each term of the second polynomial may be n². In this case, as will be described later in FIG. 8, according to an embodiment, the processor 120 may reference both the positive number table and the negative number table with respect to each partial product.

Alternatively, according to an embodiment, the processor 120 may reference one of the positive number table and the negative number table with respect to each partial product. Accordingly, in the case of the former embodiment, the processor 120 may perform a lookup table reference operation 2n² times as an operation of obtaining the results of modular arithmetic on partial products. In the meantime, in the case of the latter embodiment, the processor 120 may perform a lookup table reference operation n² times as an operation of obtaining the results of modular arithmetic on partial products. However, an embodiment of the present disclosure is not limited thereto.

In operation S720, the processor 120 may generate the result of the modular arithmetic on the product of the first input ‘A’ and the second input ‘B’ based on the addition arithmetic of the obtained results of modular arithmetic. In the above-described example, the number of partial products is n², and thus the processor 120 may perform an addition arithmetic operation n²−1 times in operation S720. However, an embodiment of the present disclosure is not limited thereto.

In the meantime, according to an embodiment of the present disclosure, at least one of the acquisition order of modular arithmetic results on the partial products or the order of addition arithmetic of the results of modular arithmetic may be randomly determined. Accordingly, the processor 120 may obtain results of modular arithmetic on partial products depending on the randomly determined acquisition order or addition arithmetic order. Moreover, the processor 120 may perform addition arithmetic of the results of modular arithmetic depending on the randomly determined acquisition order or addition arithmetic order.

In the meantime, according to an embodiment, the at least one lookup table LUT may include the positive number table and the negative number table for each degree of a decomposition factor. Here, the positive number table may include the results of pre-computed modular arithmetic having a positive value as elements. Here, the negative number table may include the results of pre-computed modular arithmetic having a negative value as elements.

In the meantime, according to an embodiment, when an intermediate result of addition arithmetic is a positive number, the processor 120 may add the result of modular arithmetic, which is obtained with reference to the negative number table, to the intermediate result. Moreover, when the intermediate result of addition arithmetic is a negative number, the processor 120 may add the result of modular arithmetic, which is obtained with reference to the positive number table, to the intermediate result.

Meanwhile, according to an embodiment, the at least one lookup table LUT may include a plurality of lookup table sets according to the value of a decomposition factor. Accordingly, the processor 120 may randomly determine one of the plurality of lookup table sets and may respectively decompose the first input ‘A’ and the second input ‘B’ into the first polynomial and the second polynomial based on the value of the decomposition factor corresponding to the determined lookup table set. Moreover, the processor 120 may obtain the results of modular arithmetic on partial products with reference to lookup tables included in the determined lookup table set.

FIG. 8 is a flowchart of a modular multiplication method, according to an embodiment of the present disclosure. The modular multiplication method in FIG. 8 may be an implementation example of the modular multiplication method in FIG. 7, but is not limited thereto.

Referring to FIG. 8, in operation S810, the processor 120 may determine the decomposition factor ‘r’. According to an embodiment, the processor 120 may determine the decomposition factor ‘r’ based on a random number provided by the random number generator 130 and may determine a lookup table set based on the determined decomposition factor ‘r’. Alternatively, according to an embodiment, the processor 120 may determine the decomposition factor ‘r’ and a value ‘x’ based on the random number provided by the random number generator 130 and may determine the lookup table set based on the determined decomposition factor ‘r’ and the value ‘x’.

In operation S820, the processor 120 may decompose the first input ‘A’ and the second input ‘B’ into the first polynomial and the second polynomial based on the decomposition factor ‘r’. Accordingly, the processor 120 may identify the above-described partial products by identifying the multiplication combination of each term of a first polynomial and each term of a second polynomial.

In operation S830, the processor 120 may initialize an intermediate result of addition arithmetic. For example, when a variable related to the intermediate result of the addition arithmetic of the results of the modular arithmetic on partial products is “acc”, the processor 120 may initialize the value of acc to ‘0’.

In operation S840, the processor 120 may determine whether the results of modular arithmetic are obtained on all partial products. As described above, the result of modular arithmetic on partial product is obtained with reference to the lookup table, and thus the processor 120 according to an embodiment may determine whether the results of modular arithmetic are obtained on the partial products by identifying a lookup table reference history with respect to the partial products.

When the identified result indicates that the result of modular arithmetic is not obtained on all partial products, in operation S850, the processor 120 may select a partial product for obtaining the result of modular arithmetic. In this case, according to an embodiment, the processor 120 may randomly select a partial product (i.e., a partial product for obtaining the result of modular arithmetic) for referencing a lookup table based on the random number provided by the random number generator 130.

In this case, according to an embodiment, when the selected partial product is a partial product that has been already selected before (i.e., when the selected partial product is a partial product on which the result of modular arithmetic has already been obtained), the processor 120 may again randomly select another partial product. Moreover, when the selected partial product is a partial product that has not been selected before (i.e., when the result of modular arithmetic is a partial product that has not yet been obtained), the processor 120 may delete the corresponding partial product from the selectable partial product list.

In operation S860, the processor 120 may obtain the result of modular arithmetic on the selected partial product with reference to the lookup table. In this case, according to an embodiment, the processor 120 may reference both the positive number table and the negative number table corresponding to the selected partial product. In this case, in operation S870, the processor 120 may identify the value of a current intermediate result (i.e., a current acc value). Accordingly, when the identified acc value is a positive number, the processor 120 may add the result of modular arithmetic obtained with reference to the negative number table to the current acc value. Moreover, when the identified acc value is a negative number, the processor 120 may add the result of modular arithmetic obtained with reference to the positive number table to the current acc value. When the value of the identified acc is 0, the processor 120 may randomly add one of a value obtained by referencing the positive number table or a value obtained by referencing the negative number table to the acc value.

In the meantime, according to an embodiment, in operation S860, the processor 120 may identify a value (i.e., a current acc value) of the current intermediate result and may select a lookup table to be referenced from among the positive number table and the negative number table based on the identified acc value. For example, when the identified acc value is a positive number, the processor 120 may obtain the result of modular arithmetic with reference to the negative number table. Moreover, when the identified acc value is a negative number, the processor 120 may obtain the result of modular arithmetic with reference to the positive number table. When the identified acc value is 0, the processor 120 may randomly select one of the positive number table and the negative number table and may obtain the result of modular arithmetic. In this case, in operation S870, the processor 120 may add the result of modular arithmetic, which is obtained through operation S860, to the acc value.

When it is identified that the result of modular arithmetic has been obtained on all partial products in operation S850, in operation S880, the processor 120 may adjust the intermediate result (i.e., acc value) to a predetermined range. For example, the case where it is identified that the results of the modular arithmetic have been obtained on all partial products may be the case where the addition arithmetic of the results of the modular arithmetic on all partial products is completed through repeated operations of operations S850 to S870. In this case, the acc value may have a value ranging from −xQ to xQ. Accordingly, for example, when the desired range of the result of the final modular multiplication is predetermined to a range of 0 to Q, the processor 120 may perform an operation of adjusting the value of the intermediate result at a point in time, when the addition arithmetic is completed, to a predetermined range. Accordingly, the result of modular arithmetic on the product of the first input ‘A’ and the second input ‘B’ may be finally adjusted to a value within a predetermined range.

FIG. 9 is a flowchart of adjustment of an intermediate result, according to an embodiment of the present disclosure. An operation of FIG. 9 may be an example of a specific operation in operation S880 of FIG. 8, but is not limited thereto.

Referring to FIG. 9, in operation S910, the processor 120 may set variable ‘m’ to value ‘x’. In this case, as described above in Equation 4, ‘x’ may be a positive integer for determining a range of a value indicated by the result of modular arithmetic on partial products.

In operation S920, the processor 120 may determine whether value ‘m’ is 0. When value ‘m’ is not 0, in operation S930, the processor 120 may determine whether the value (e.g., an acc value in operation S880 of FIG. 8) of an intermediate result is greater than or equal to 0. When the identified result indicates that the acc value is greater than or equal to 0, in operation S940, the processor 120 may subtract Q from the acc value. Moreover, when the identified result indicates that the acc value is smaller than 0, in operation S950, the processor 120 may add Q to the acc value.

Afterwards, in operation S960, the processor 120 may subtract 1 from value ‘m’. A series of operations in operations S930 to S960 may be an operation of adjusting the acc value in a range of from −Q to Q.

In the meantime, when it is identified that value ‘m’ is 0 in operation S920, in operation S970, the processor 120 may determine whether the acc value is greater than or equal to 0. The case where the acc value is greater than or equal to 0 is the case where the acc value belongs to a range between 0 and Q, and thus an operation of adjusting the intermediate result may be completed. In the meantime, the case where the acc value is smaller than 0 is the case where the acc value belongs to a range between −Q and 0, and thus the processor 120 may add Q to the acc value in operation S980. Accordingly, the acc value belongs to the range between 0 and Q, and the operation of adjusting the intermediate result may be terminated.

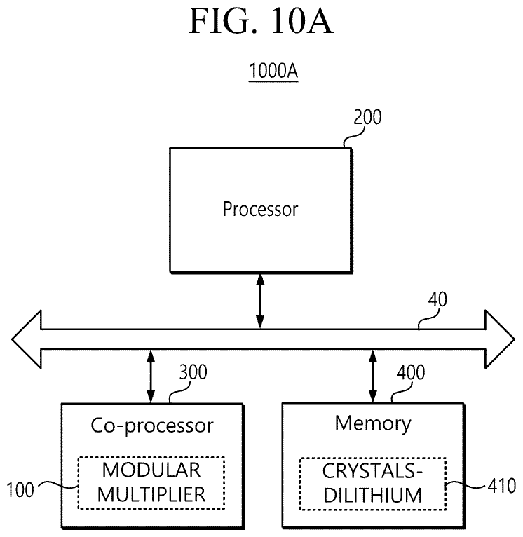

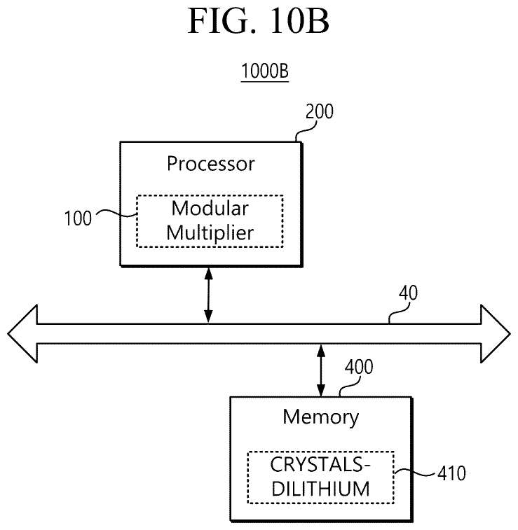

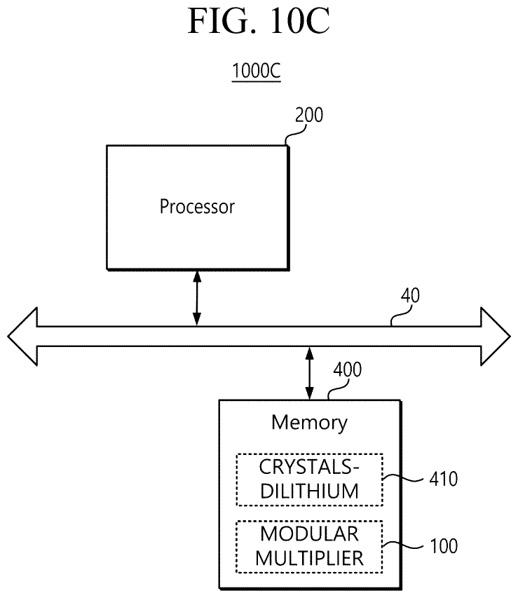

Hereinafter, various implementation examples of the modular multiplier 100 or 100A will be described with reference to FIGS. 10A to 10C. FIG. 10A is a diagram showing an implementation example of a

modular multiplication system, according to an embodiment of the present disclosure. Referring to FIG. 10A, a modular multiplication system 1000A may include a processor 200, a co-processor 300, and a memory 400. The processor 200, the co-processor 300, and the memory 400 may exchange data with each other through a bus 40.

The memory 400 may be used as a main memory device of the modular multiplication system 1000A and may include a volatile memory such as SRAM and/or DRAM. Moreover, the memory 400 may include a non-volatile memory such as flash memory, PRAM and/or RRAM.

The co-processor 300 may be an accelerator for various operations performed by the processor 200. In this case, the co-processor 300 may include the modular multiplier 100 according to various embodiments of the present disclosure described above.

The processor 200 controls overall operations of the modular multiplication system 1000A. The processor 200 may include one or more a central processing unit (CPU), a controller, an application processor (AP), a microprocessor unit (MPU), a communication processor (CP), a graphic processing unit (GPU), a vision processing unit (VPU), a neural processing unit (NPU), or an ARM processor.

In particular, the processor 200 may execute a CRYSTALS-DILITHIUM algorithm 410 stored in the memory 400. In this case, the processor 200 may perform various modular multiplication arithmetic required in an operating process (e.g., an operation of decrypting a private key, creating an electronic signature, or the like) of the CRYSTALS-DILITHIUM algorithm 410 by executing the modular multiplier 100 implemented as the co-processor 300. For example, the processor 200 may provide the modular multiplier 100 with coefficients of a private key and a private key. In this case, the coefficients of the private key and the private key may be the first input ‘A’ and the second input ‘B’ described above. Moreover, the processor 200 may receive the result of modular multiplication between the coefficients from the modular multiplier 100.

FIG. 10B is a diagram showing an implementation example of a modular multiplication system, according to an embodiment of the present disclosure. In describing FIG. 10B, the content described above in FIG. 10A is omitted to avoid redundancy. Referring to FIG. 10B, a modular multiplication system 1000B may include the processor 200 and the memory 400. In this case, according to an embodiment, as shown in FIG. 10B, the modular multiplier 100 described above may be implemented inside the processor 200. In this case, the processor 200 may directly use the inside modular multiplier 100 in an execution process of the CRYSTALS-DILITHIUM algorithm 410.

FIG. 10C is a diagram showing an implementation example of a modular multiplication system, according to an embodiment of the present disclosure. In describing FIG. 10C, the content described above in FIG. 10A is omitted to avoid redundancy. Referring to FIG. 10C, a modular multiplication system 1000C may include the processor 200 and the memory 400. In this case, according to an embodiment, as shown in FIG. 10C, the modular multiplier 100 described above may be implemented with software and may be stored in the memory 400. In this case, the processor 200 may use the modular multiplier 100 in an execution process of the CRYSTALS-DILITHIUM algorithm 410 by executing the modular multiplier 100 stored in the memory 400.

The modular multiplication systems 1000A, 1000B, and 1000C described above in FIGS. 10A to 10C may be implemented as various electronic devices such as smartphones, tablets, laptops, PCs, smart TVs, smart home appliances, wearable devices, healthcare devices, servers, and navigation systems.

In the meantime, according to an embodiment, the memory 110 of the modular multiplier 100 or 100A may be replaced with the memory 400 of FIGS. 10A to 10C. That is, the lookup table(s) including the results of the pre-computed modular arithmetic described above may be stored in the memory 400, and the processor 120 of the modular multiplier 100 or 100A may perform the above-described operations with reference to the lookup table(s) stored in the memory 400. Moreover, according to an embodiment, the random number generator 130 of the modular multiplier 100 or 100A may also be replaced with another random number generator outside the modular multiplier 100 or 100A.

Moreover, FIGS. 10A to 10C illustrate that the processor 200 of the modular multiplication system 1000A, 1000B, or 1000C uses the modular multiplier 100 in a process of executing CRYSTALS-DILITHIUM stored in the memory 400, but an embodiment is not limited thereto. According to an embodiment, other cryptographic algorithms such as CRYSTALS-KYBER and FALCON may be mounted on the memory 400 and may be executed by the processor 200. When modular multiplication is needed in the process, the modular multiplier 100 may be used.

According to various embodiments of the present disclosure, modular multiplication arithmetic may be safely performed against side-channel attacks through power pattern analysis. Moreover, a lookup table for modular multiplication may be configured by using a relatively small amount of memory compared to a general technology.

According to an embodiment, an operating method of the modular multiplier 100 or 100A according to various embodiments of the present disclosure may be included and provided in a computer program product. The computer program product may be traded between a seller and a buyer as a product. The computer program product may be distributed in the form of a machine-readable storage medium (e.g., compact disc read only memory (CD-ROM)) or may be distributed through an application store (e.g., PlayStore™) online. In the case of on-line distribution, at least part of the computer program product may be at least temporarily stored in the storage medium such as the memory of a manufacturer's server, an application store's server, or a relay server or may be generated temporarily.

Each of components (e.g., a module or a program) according to various embodiments may include a single entity or a plurality of entities; some of the above-described corresponding sub components may be omitted, or any other sub component may be further included in various embodiments. Alternatively or additionally, some components (e.g., a module or a program) may be combined with each other so as to form one entity, so that the functions of the components may be performed in the same manner as before the combination. According to various embodiments, operations executed by modules, program modules, or other components may be executed by a successive method, a parallel method, a repeated method, or a heuristic method. Alternatively, at least some of the operations may be executed in another order or may be omitted, or any other operation may be added.

The above description refers to detailed embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments described above, it will be apparent to those of ordinary skill in the art that various changes and modifications may be made thereto without departing from the spirit and scope of the present disclosure as set forth in the following claims.

According to various embodiments of the present disclosure, it is possible to provide a modular multiplier, a modular multiplication method, and a modular multiplication system that may safely perform modular multiplication arithmetic against side-channel attacks through power pattern analysis.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A modular multiplier comprising:
a random number generator configured to generate a random number;
a memory configured to store at least one lookup table including results of pre-computed modular arithmetic; and
a processor configured to:
obtain results of modular arithmetic on partial products defined by a product of a first polynomial corresponding to a first input and a second polynomial corresponding to a second input with reference to the at least one lookup table; and
generate a result of modular arithmetic on a product of the first input and the second input based on addition arithmetic of the obtained results of the modular arithmetic,
wherein the processor is further configured to:
randomly determine at least one of an order of the addition arithmetic or an acquisition order of modular arithmetic results on the partial products based on the random number generated by the random number generator.

2. The modular multiplier of claim 1, wherein the processor is further configured to:
decompose the first input and the second input into the first polynomial and the second polynomial based on a decomposition factor, respectively.

3. The modular multiplier of claim 2, wherein the partial products are multiplication combinations of each term of the first polynomial developed based on the decomposition factor, and each term of the second polynomial developed based on the decomposition factor.

4. The modular multiplier of claim 2, wherein the at least one lookup table includes a positive number table and a negative number table for each degree of the decomposition factor,
wherein the positive number table includes the results of the pre-computed modular arithmetic having a positive value as elements, and
wherein the negative number table includes the results of the pre-computed modular arithmetic having a negative value as elements.

5. The modular multiplier of claim 4, wherein the positive number table includes xr² elements having a value between 0 and xQ,
wherein the negative number table includes xr² elements having a value between −xQ and 0, and
wherein the ‘r’ is a value of the decomposition factor, the Q is a value of modulus used in the modular arithmetic, and the ‘x’ is one of positive integers.

6. The modular multiplier of claim 5, wherein each of the results of the modular arithmetic on the partial products has a value between −xQ and xQ.

7. The modular multiplier of claim 4, wherein the processor is further configured to:
when an intermediate result of the addition arithmetic is a positive number, add a result of modular arithmetic, which is obtained with reference to the negative number table, to the intermediate result; and
when the intermediate result of the addition arithmetic is a negative number, add a result of modular arithmetic, which is obtained with reference to the positive number table, to the intermediate result.

8. The modular multiplier of claim 5, wherein the processor is further configured to:
when a positive number is added to a positive number during the addition arithmetic, subtract xQ from the added value; and
when a negative number is added to a negative number during the addition arithmetic, add xQ to the added value.

9. The modular multiplier of claim 1, wherein the processor is further configured to:
sequentially obtain the results of the modular arithmetic on the partial products depending on the determined order of the addition arithmetic and the determined acquisition order; and
sequentially perform the addition arithmetic depending on an order in which the results of the modular arithmetic are obtained.

10. The modular multiplier of claim 1, wherein the processor is further configured to:
after obtaining all the results of the modular arithmetic on the partial products depending on the determined acquisition order, perform addition arithmetic of the obtained results of the modular arithmetic depending on the determined order of the addition arithmetic.

11. The modular multiplier of claim 2, wherein the at least one lookup table includes a plurality of lookup table sets according to a value of the decomposition factor, and
wherein the processor is further configured to:
determine one of the plurality of lookup table sets based on the random number generated by the random number generator;
respectively decompose the first input and the second input into the first polynomial and the second polynomial based on a value of a decomposition factor corresponding to the determined lookup table set; and
obtain the results of the modular arithmetic on the partial products with reference to elements of a lookup table included in the determined lookup table set.

12. The modular multiplier of claim 1, wherein a value of modulus Q used in the modular arithmetic is 8380417.

13. The modular multiplier of claim 2, wherein the processor is further configured to:
when the first input is ‘A’ and the second input is ‘B’, decompose the ‘A’ and the ‘B’ based on Equation 1:
$$A = {\sum }_{0}^{n - 1} {a}_{i} \cdot {r}^{i} , and B = {\sum }_{0}^{n - 1} {b}_{j} \cdot {r}^{j} ,$$
and
wherein each of the ‘A’ and the ‘B’ denotes a number smaller than modulus Q used in the modular arithmetic, the ‘r’ denotes the decomposition factor, the Σ₀ⁿ⁻¹aᵢ·rⁱ denotes the first polynomial, the Σ₀ⁿ⁻¹bⱼ·r^{j} denotes the second polynomial, the ‘a’ denotes a coefficient of the first polynomial, the ‘b’ denotes a coefficient of the second polynomial, the ‘n’ denotes ceil(k/log₂(r)), the ceil denotes a function that rounds up to a nearest integer, and the ‘k’ denotes a number of bits of the modulus Q.

14. The modular multiplier of claim 13, wherein when a product of the first polynomial and the second polynomial is expressed based on Equation 2:
$$A \cdot B = {\sum }_{0}^{n - 1} {\sum }_{0}^{n - 1} ( {a}_{i} \cdot {b}_{j} \cdot {r}^{i + j} ) ,$$
the partial products correspond to aᵢ·bⱼ·r^{i+j}.

15. A modular multiplication method, the method comprising:
obtaining, by a processor, results of modular arithmetic on partial products defined by a product of a first polynomial corresponding to a first input and a second polynomial corresponding to a second input with reference to at least one lookup table including results of pre-calculated modular arithmetic; and
generating, by the processor, a result of modular arithmetic on a product of the first input and the second input based on addition arithmetic of the obtained results of the modular arithmetic,
wherein at least one of an order of the addition arithmetic or an acquisition order of modular arithmetic results on the partial products is randomly determined.

16. The method of claim 15, further comprising:
decomposing, by the processor, the first input and the second input into the first polynomial and the second polynomial based on a decomposition factor, respectively,
wherein the partial products are multiplication combinations of each term of the first polynomial developed based on the decomposition factor, and each term of the second polynomial developed based on the decomposition factor.

17. The method of claim 16, wherein the at least one lookup table includes a positive number table and a negative number table for each degree of the decomposition factor,
wherein the positive number table includes the results of the pre-computed modular arithmetic having a positive value as elements, and
wherein the negative number table includes the results of the pre-computed modular arithmetic having a negative value as elements.

18. The method of claim 17, wherein the generating includes:
when an intermediate result of the addition arithmetic is a positive number, adding a result of modular arithmetic, which is obtained with reference to the negative number table, to the intermediate result; and
when the intermediate result of the addition arithmetic is a negative number, adding a result of modular arithmetic, which is obtained with reference to the positive number table, to the intermediate result.

19. The method of claim 16, wherein the at least one lookup table includes a plurality of lookup table sets according to a value of the decomposition factor, wherein the method further comprises:
randomly determining one of the plurality of lookup table sets,
wherein the decomposing includes:
decomposing the first input and the second input into the first polynomial and the second polynomial based on a value of a decomposition factor corresponding to the determined lookup table set, respectively, and
wherein the obtaining includes:
obtaining the results of the modular arithmetic on the partial products with reference to lookup tables included in the determined lookup table set.

20. A modular multiplication system comprising:
a memory configured to store an encryption algorithm;
a modular multiplier; and
a processor configured to execute the encryption algorithm and to provide a first input and a second input with the modular multiplier,
wherein the modular multiplier is configured to:
obtain results of modular arithmetic on partial products defined by a product of a first polynomial corresponding to the first input and a second polynomial corresponding to the second input with reference to at least one lookup table including results of pre-calculated modular arithmetic; and
generate a result of modular arithmetic on a product of the first input and the second input based on addition arithmetic of the obtained results of the modular arithmetic,
wherein the modular multiplier is further configured to:
randomly determine at least one of an order of the addition arithmetic or an acquisition order of modular arithmetic results on the partial products; and
return the generated result of the modular arithmetic on the product of the first input and the second input to the processor.
